(19) United States
(12) Patent Application Publication
(10) Pub. No.: US 2012/0304850 A1
(43) Pub. Date: Dec. 6, 2012

(54) DEVICE FOR LOCKING AN AXIALLY MOVABLE COMPONENT OF A HYDRAULIC SYSTEM

(76) Inventor: Winfried Rüb, Waldshut-Tiengen (DE)

(21) Appl. No.: 13/261,386

(22) PCT Filed: Mar. 5, 2011
(86) PCT No.: PCT/EP2011/001092

§ 371 Date: Jul. 26, 2012

(30) Foreign Application Priority Data
Mar. 20, 2010 (DE) 10 2010 012 158.4

(51) Int. Cl. F15B 15/26

(52) U.S. Cl. 92/27

(57) ABSTRACT

The invention relates to a device for locking an axially movable component (2) of a hydraulic system, wherein the axially movable component (2) can be detachably fixed in a positively locking manner in at least one axial position by means of a detent mechanism (4) with at least one detent body (5), and with a release device (6) for releasing the respective detent body (5) from the axially movable component (2), wherein the detent mechanism (4) can be latched and released by means of a clamping piston (7) and using a force store (8), and wherein the clamping piston (7) can be moved in a working chamber (27) which can be charged with a clamping pressure, which device is characterized in that the clamping piston (7) can be adjusted at least into one switching position by a switching device (9), in that the clamping piston (7) can be acted on with the clamping pressure by means of the switching device (9) and, in said switching position, can be moved out of the latching position thereof by the force store (8) in the event of a withdrawal of the clamping pressure.

The invention relates to a device for locking an axially movable component of a hydraulic system, wherein the axially movable component can be releasably secured in a positively locking manner in at least one axial position by means of a detent mechanism with a detent body, and with a release device for releasing the detent body from the axially movable component, wherein the detent mechanism can be latched and released by means of a clamping piston and with the use of an energy storage mechanism, and wherein the clamping piston can be moved in a working chamber, which can be subject to the action of a clamping pressure.

In hydraulic systems, the directional control valves perform a wide range of actuating tasks for such actuators as hydraulic cylinders and the like by means of a number of control ports and switching positions in order to be able to operate, for example, any kind of working tool that is attached. In particular, in the event that the safety of the operating person of such a hydraulic system, as those used, for example, in utility vehicles, is at risk, it is necessary to return such directional control valves into a neutral position after the hydraulic system has been shut off. Such a strategy can prevent, for example, an inadvertent positioning movement of the working tools or can prevent the other hydraulic consumers from an unintentional startup when the hydraulic system is put into operation again. In particular, when there is an undesired drop in the hydraulic fluid pressure in the hydraulic system, it is also mandatory that such hydraulic systems have such an automatic safety device in order to rule out the possibility that such an undesired pressure may cause positioning movements or inverse directions of rotation by the hydraulic actuators and motors that is different from what is actually desired.

DE 39 23 743 A1 discloses a hydraulic directional control valve with a locking device that secures the control slide in a working position. The locking device has a release device for the control slide of the directional control valve, so that in the event that there is an overpressure or also in the event of a corresponding low pressure, the control slide can be returned into its neutral central position. For this purpose, the locking device has a pressure valve that responds to overpressure; and the locking device has a piston member and a piston with a spring type accumulator, which responds to low pressure. Both the piston and the piston member are operatively connected to a cone that relieves the detent balls that are situated in the latching position, so that the control slide can be moved into its neutral central position.

EP 1 446 599 B1 discloses in turn a device for locking an axially movable component, such as a control slide of a hydraulic directional control valve, by means of which the axially movable component can be held in axial positions by means of a detent mechanism. The detent mechanism can be released by means of a release device for releasing detent bodies from the axially movable component. Furthermore, the latching positions, which the detent mechanism enables, are variably adjustable by changing a position of a coding body. Thus, the embodiment shows a mechanical coding that enables a plurality of operating configurations of the directional control valve and, as a result, allows the directional control valve to have a wide range of operating states.

DE 41 07 980 A1 discloses a generic, hydraulically operated detent device for a part that can be moved longitudinally relative to a stationary part by means of a radially movable ball. The ball is disposed in a transverse borehole of a stationary, sleeve-shaped part and in the latching position can penetrate into a latching groove on the movable part and in the unlocking position engages with a groove on a radially external slide sleeve. Furthermore, the detent device has a hydraulic fluid connection from a hydraulic fluid source to a pressure chamber, defined by the movable part, so that one portion of the hydraulic fluid connection is formed in the movable part itself. The longitudinally movable part is typically a piston, which is mechanically locked by means of a detent device after a certain sliding distance. In this position, the slide sleeve rests with its front side against one end of the tube; and the compression spring is completely preloaded. If the piston is to be moved out, then the hydraulic fluid is introduced into the pressure chamber under a respectively high pressure by way of a borehole. This hydraulic fluid is instrumental in building up the pressure which moves the slide sleeve against the force of the compression spring, so that the annular groove can move into the region of the ball; and the piston can be unlocked again.

The fact that the control slide is always unlocked when a certain working pressure is reached may be regarded as a disadvantage of the prior art device. In contrast, a permanent detent mechanism or a deactivated detent mechanism and an operating mode that is carried out with such a configuration of the component or, more specifically, a directional control valve is not possible.

Based on this prior art, the object of the present invention is to provide a device for locking an axially movable component of a hydraulic system, in particular for locking a control slide, and that does not have the aforementioned drawbacks.

This object is achieved with a device for locking an axially movable component having the features specified in claim 1 in its entirety.

An especially advantageous feature of the device that characterizes the invention is that the clamping piston can be adjusted at least into one switching position by a switching device. The switching device provides, on the one hand, that the clamping pressure is applied to the clamping piston; and in this first switching position, which is referred to as the “kick-out switching position,” the clamping piston can also be moved out again of its latching position by means of the energy storage mechanism when there is a drop in the clamping pressure. On the other hand, at least two additional switching positions can be provided preferably with the switching device. In this case, an additional second switching position serves to remove the hydraulic fluid from the clamping piston into a hydraulic fluid container so that the control slide can return into a neutral position. A third switching position of the switching device provides that the clamping piston is preferably locked in each respectively occupied switching position, in particular in the latching position.

The component can be a control slide of a hydraulic directional control valve. An especially preferred exemplary embodiment provides that a load pressure of a consumer, which is controlled preferably by the directional control valve, is applied as the clamping pressure to the switching device. As a result, when the hydraulic fluid pump is switched on, a latching function is not possible in a working position of a hydraulic tool. When the hydraulic fluid pump starts up again, such a strategy prevents, with a high degree of certainty, the control slide of the directional control valve from being in a position in which a working port is connected directly to the hydraulic fluid pump that conveys the hydraulic fluid and, thus, prevents a dangerous, unintentional actuation of a consumer (safety function).

A so-called “kick-out” function of the switching device is designed to cancel the latching action when a predefined load is reached at the working port of the directional control valve and is designed to eject (kick-out) the valve slide from the latching position with the aid of the energy storage mechanism.

It is preferred that the switching device can be manually operated; and it is preferred that three switching positions or operating modes can be provided for the detent mechanism. Since the switching device controls the pressure applied to the clamping piston for the detent mechanism, a second switching position of a valve member of the switching device can cause the clamping piston to be permanently unloaded by connecting the working chamber of the clamping piston to a hydraulic fluid container in order to drain the working chamber and by suppressing a connection of the working chamber of the clamping piston to a load pressure of a consumer. The result is that the detent mechanism is permanently deactivated.

In a third switching position of the switching device, the supply and removal of the hydraulic fluid to and from the working chamber of the clamping piston can be blocked. The result is a blocking position of the clamping piston. The various switching positions can be selected with a rotary switch or a control knob; and all three switching positions of the valve member of the switching device can be selected by turning the control knob 180° or less.

At the same time, the valve member of the switching device can perform a combined rotational or translational movement, which can be implemented in a very space-saving way with, for example, a control piston.

In a neutral position or central position, the “kick-out” function is implemented by applying a clamping pressure to the clamping piston for the detent mechanism. The two additional switching positions can be provided to the left and the right of this neutral position. In one embodiment of the device that is characterized by its very low installation space requirement, this device is integrated into a housing of the directional control valve; and a longitudinal axis of the switching piston is arranged in parallel to a longitudinal axis of the valve member of the directional control valve.

The device according to the invention lends itself, in particular, to an arrangement in hydraulic systems of utility vehicles, such as so-called farm tractors.

The device according to the invention is described in detail below by means of one exemplary embodiment with reference to the accompanying drawings. Referring to the drawings:

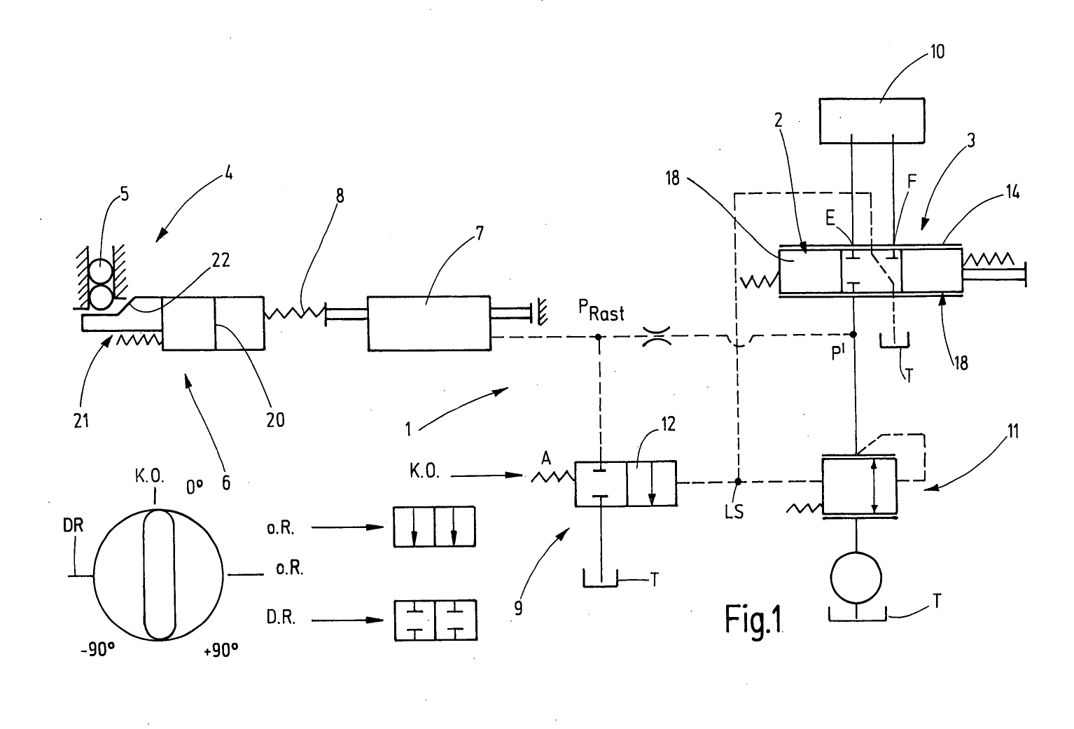

FIG. 1 shows a schematic circuit diagram of a device for locking an axially movable component of a hydraulic system;

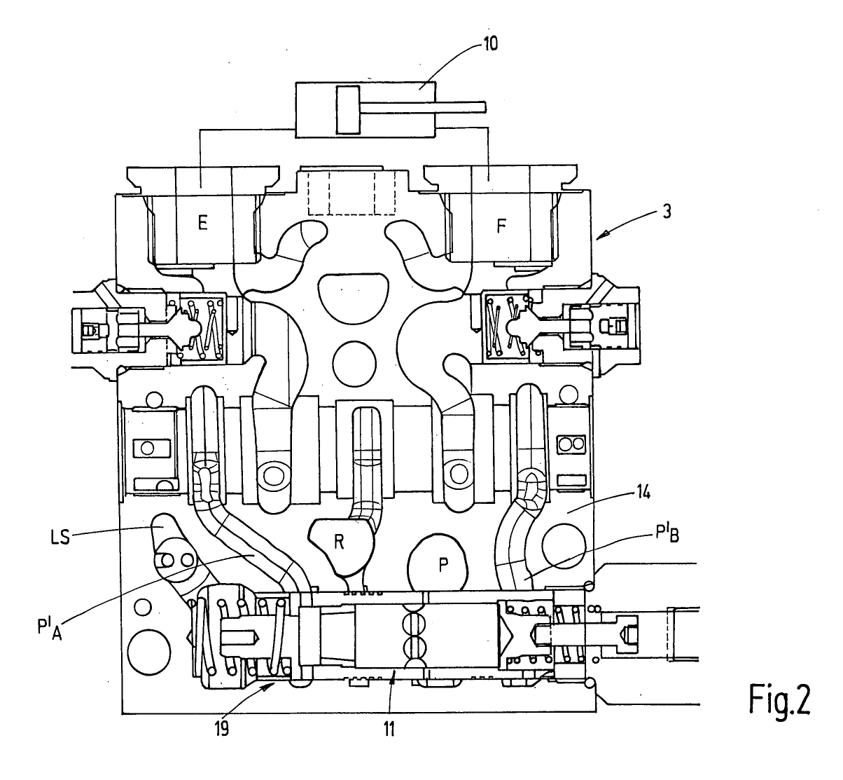

FIG. 2 is a schematic, longitudinal view of a hydraulic directional control valve (not drawn to scale) for connecting the device for locking according to the FIGS. 2′ to 7;

FIG. 2′ is a schematic, longitudinal view of the device (not drawn to scale) for locking the axially movable component in a home position;

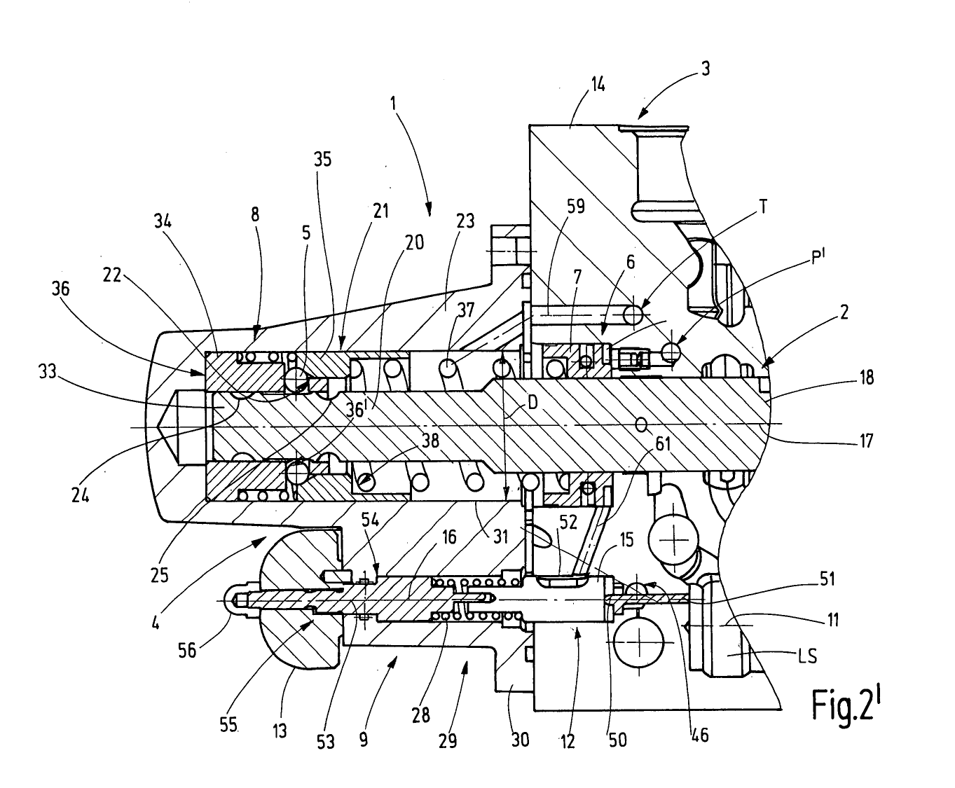

FIG. 3 is a schematic, longitudinal view of the device (not drawn to scale) for locking the axially movable component in a permanent latching position (switching position DR/angle of rotation)−90°;

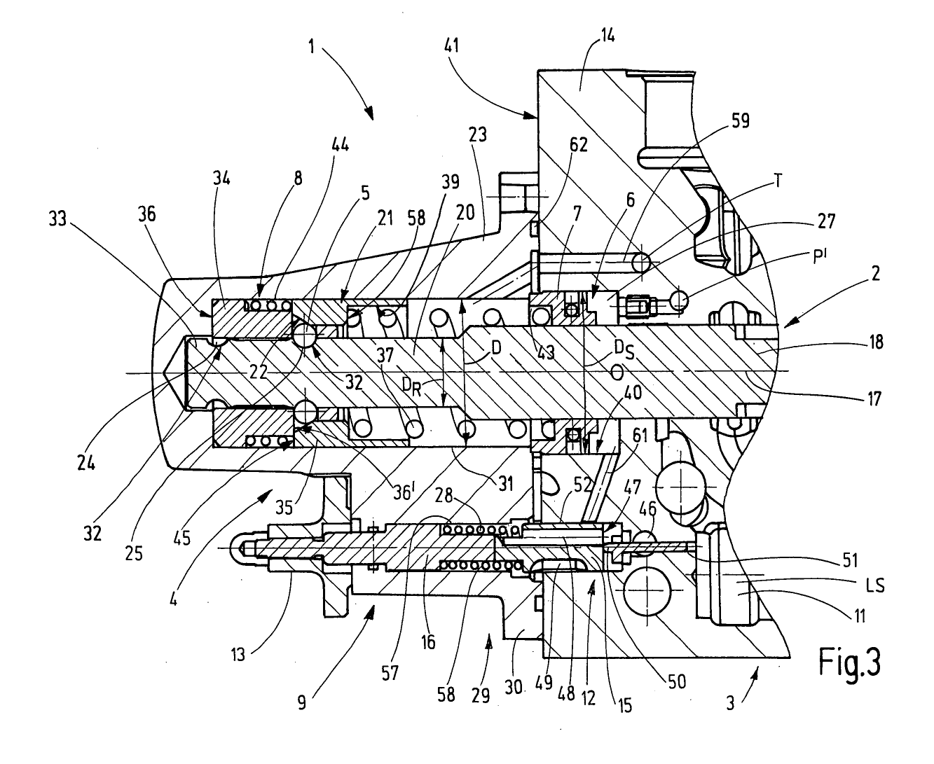

FIG. 4 is a schematic, longitudinal view of the device (not drawn to scale) for locking the axially movable component in a “kick-out” operational position (switching position K.O./angle of rotation 0°);

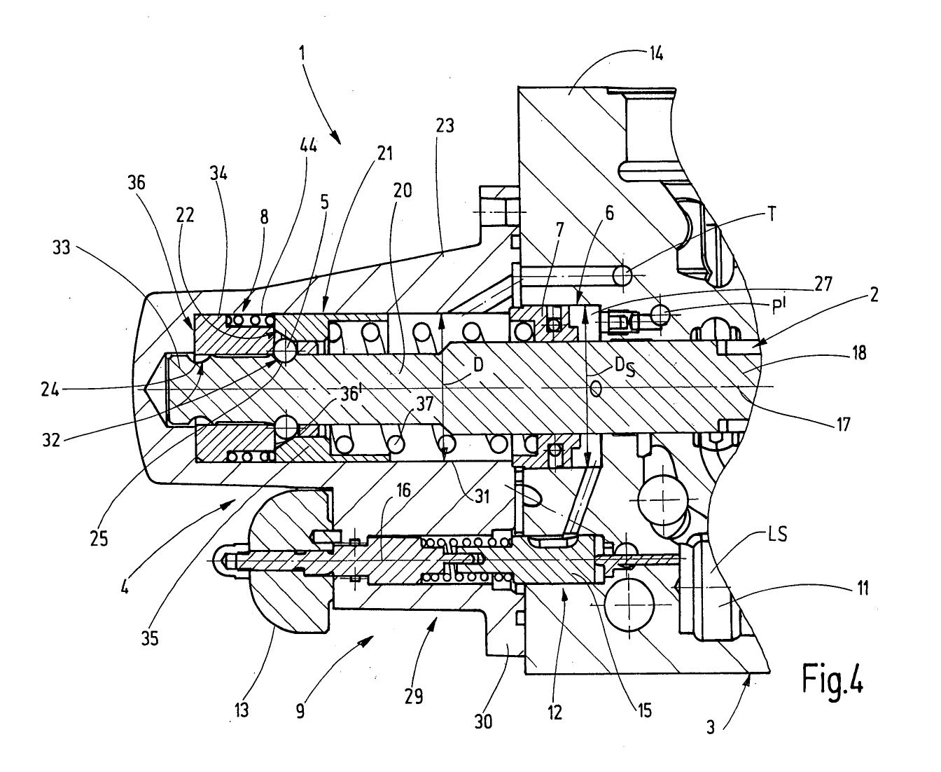

FIG. 5 is a schematic, longitudinal view of the device (not drawn to scale) for locking the axially movable component in a deactivated position of a switching device (without detent/o.R. angle of rotation)+90°);

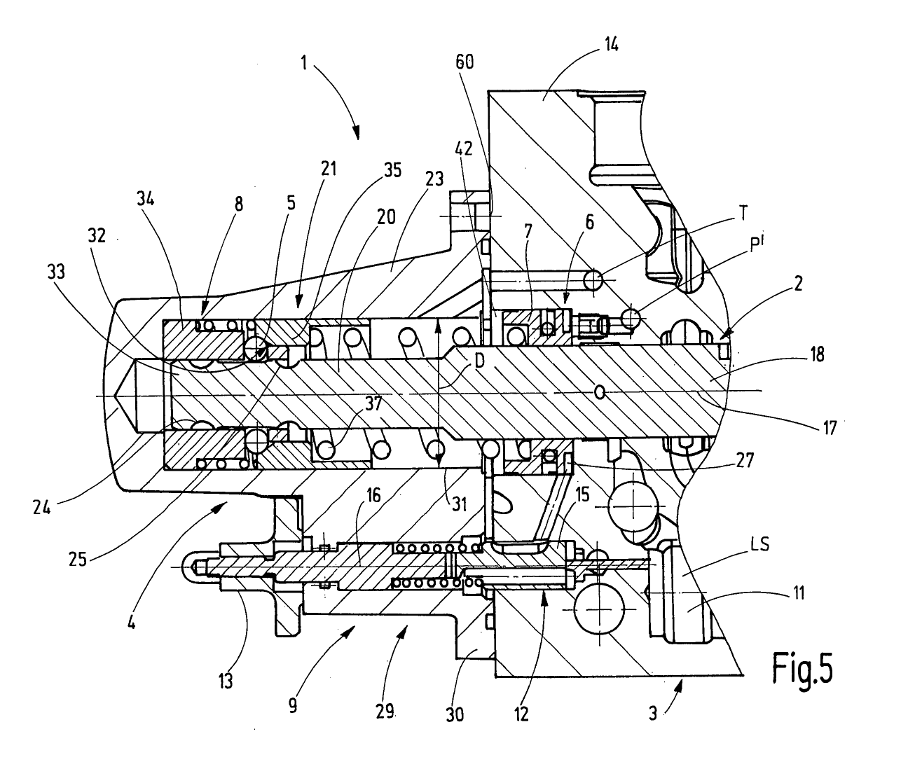

FIG. 6 is a frontal view of the device for locking the axially movable component with the switching device; and

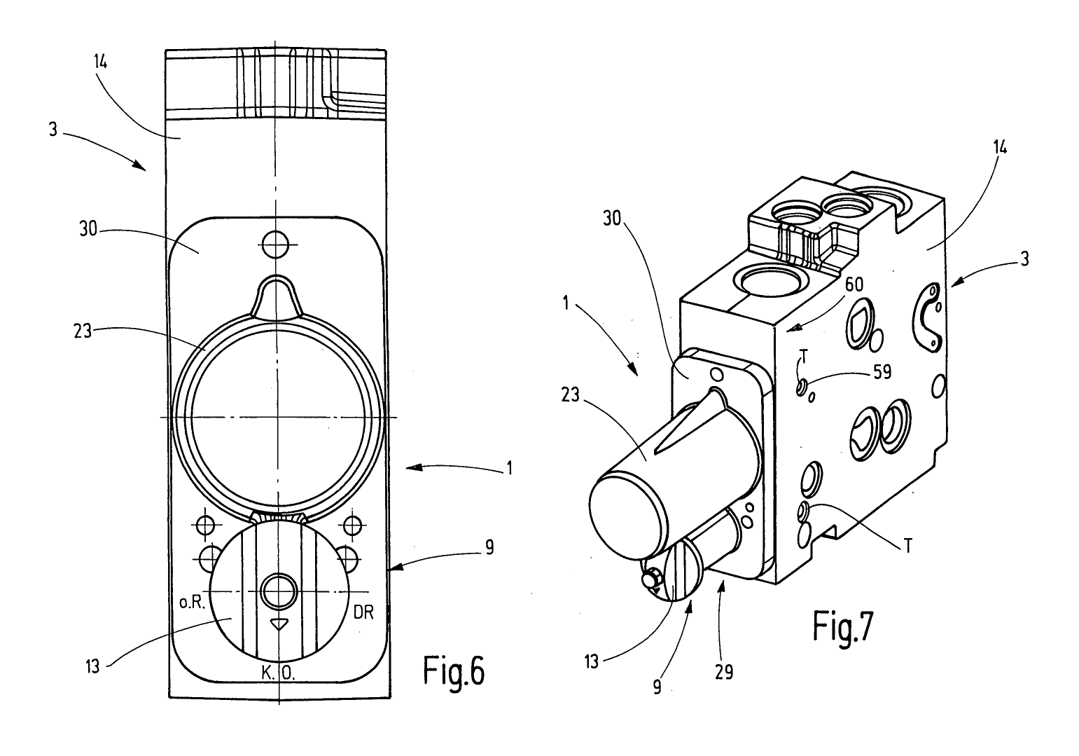

FIG. 7 is a schematic, perspective view of the device for locking the axially movable component at a directional control valve, as shown in FIG. 2.

FIG. 1 shows a schematic circuit diagram of a device 1 at a directional control valve 3 for locking a valve member 18 of the directional control valve 3. The valve member 18 is designed in the conventional manner as a valve slide and as an axially movable component 2. As shown in FIG. 2, such a directional control valve 3 has a pressure supply port P to make available a working and pump pressure, a return port R, a section load sensing port LS, two control ports P′_{A} and P′_{B} as well as two working ports E, F. The said fluid ports LS, P′_{A}, P′_{B}, R, E, F are disposed in one part of a housing 14 of the directional control valve 3. When seen in the direction of FIGS. 1 and 2, a lower section of the housing 14 has an annular channel arrangement 19, into which a pressure compensator 11 can be inserted. This pressure compensator is upstream of the directional control valve 3 and provides this directional control valve with the function of a quantity cut off by limiting the LS pressure. This feature allows the amount of hydraulic fluid, supplied to the hydraulic cylinder, to be cut off in order to prevent the hydraulic fluid pump from being overloaded when a consumer 10, which is designed as a hydraulic cylinder, is actuated. This consumer is shown only in schematic form and is designed to be situated at an end stop.

FIG. 1 shows in a highly simplified form that in order to secure the valve member 18, the device 1 for locking the valve member 18 is attached to the housing 14 of the directional control valve 3. The device 1 consists, as shown in FIG. 2′, of a detent mechanism 4 comprising a latching piston 20, which can be moved in the same axial direction as the valve member 18. The extension of this latching piston has an element 21 in the form of a conical bushing that has control or oblique surfaces 22. The control surfaces 22 act together with the individual detent bodies 5 in the form of balls, which are able to lock or correspondingly release the latching piston 20 relative to a housing 23, which is connected to the housing 14 of the directional control valve 3. In this respect, FIGS. 2′ to 7 show three switching positions A(=DR), B(=K.O.), C(=o.R.) by means of two latching recesses 24, 25 on the latching piston 20.

In order for the whole system to operate reliably, the device 1, located in its home position when seen in the direction of FIG. 2′, has to be connected to the left side of the housing 14 of the directional control valve 3, when seen in turn in the direction of FIG. 2. In so far as the directional control valve 3 and the device 1 respectively are not drawn to scale based on their port dimensions, it is still, nevertheless, within the competence of the average person skilled in the art to produce the port geometries. In this case, FIGS. 2, 2′, which vary with respect to the dimensions, still lend themselves to illustrate and describe the whole device.

FIGS. 2′ to 5 show in each case a schematic longitudinal view of the device 1 in an exemplary embodiment arranged at the directional control valve 3. The device 1 is disposed in a single housing 29. The housing 29 has a rectangular, solid flange plate 30, designed with rounded edges. The housing can be screwed by means of said flange plate to a flat front surface of the housing 14 of the directional control valve 3 from the direction of its left side. FIG. 7 shows in a perspective view that the housing 29 is formed as a cup with a shape that expands in essence conically relative to the housing 14, with this housing 29 having a cylindrical borehole 31. The borehole 31 has a diameter D that is about twice as large as the diameter of the latching piston 20, which extends through the borehole 31, in essence over its entire length.

The latching piston 20 is made, as a cylindrical rotational part, in one piece with the valve member 18 of the directional control valve 3 and has a diameter that is shorter by about ¼ of the diameter of the valve member 18 in the axial region of the flange plate 30, with the diameter in the axial region of the housing 29 being designed constant, with the exception of the turned recesses 32 forming the two latching recesses 24, 25. The turned recesses 32 have a wedge-shaped cross section. The free end 33 of the latching piston 20 is situated in a guide bushing 34. Said latching piston has a collar, which extends over somewhat less than half the length of the guide bushing and rests against the wall formed by the borehole 31. The latching piston 20 can extend through the guide bushing 34, in that the free end 33 of the latching piston can engage with a blind borehole at the tip of the housing 29 as a function of the displacement position of said latching piston. The turned recesses 32 are located in the displacement position of the latching piston 20 (shown in FIGS. 3 and 4) in the region of the respective front surfaces 36, 36′ of the guide bushing 34.

The detent bodies 5 can fall in the form of balls into the turned recesses 32. In the exemplary embodiments shown in FIGS. 2′ to 5, the control or oblique surfaces 22 are arranged relative to the housing sided end stop at a stop sleeve 35, with the oblique surfaces 22 extending in the direction of the guide bushing 34 at about 45° relative to a longitudinal axis 17 of the valve member 18, so that the detent bodies 5 or the balls are held in contact with the oblique surfaces 22 on a front side 36 of the guide bushing 34. The stop sleeve 35 is subject to the action of a cylindrical compression spring 37, which is guided at the latching piston 20 at a radial distance, and is axially supported on the stop sleeve 35 at a front surface 38, formed by an expansion of the inside diameter of the stop sleeve 35. The compression spring 37 is guided radially at an inner circumferential surface 39 of the stop sleeve 35. The stop sleeve 35 has an internal contour in the manner of a piston. The opposite end of the compression spring 37 is held in engagement with a clamping piston 7. The clamping piston 7 is arranged in an axially movable manner in a blind borehole 40, which extends through a stop face 41 for the flange plate 30. The blind borehole 40 has a slightly larger diameter Ds, so that the clamping piston 7, which is guided in said blind borehole, can be brought with its front surface 42, facing the borehole 31, into engagement with the flange plate 30.

The compression spring 37 lies in a turned recess 43 in the clamping piston 7 and is radially guided, as required. A cylindrical helical compression spring 44, which represents an energy storage mechanism 8, is disposed in an annular space between the outside circumference of the guide bushing 34 and the borehole 31. This helical compression spring applies a pressure force to a front surface 45 of the stop sleeve 35 that abuts radially outward the oblique or control surfaces 22. In this respect, the pressure force is directed counter to the pressure force of the compression spring 37.

A working chamber 27 between a bottom of the blind borehole 40 and the rear side of the clamping piston 7 can be subject to the action of a clamping pressure p, which is a load pressure P′ of the pressure compensator 11 in all of the exemplary embodiments shown in FIGS. 1 to 7. The load pressure p′ is tapped over a channel 46, which runs in the housing 14 of the directional control valve 3. In this case, the channel 46 has only the dimension of a control pressure line. The channel 46 abuts a front surface 47 of a valve member 12 of a switching device 9; and this valve member is formed as a control piston 15. The control piston 15 is aligned with its longitudinal axis 16 parallel to the longitudinal axis 17 of the valve member 18 and has, on the one hand, as shown in a longitudinal view in FIG. 3, a passage borehole 48, which extends axially through the control piston 15.

The passage borehole 48 is off-centered. Furthermore, on the outside circumference of the control piston 15, there is, opposite the passage borehole 48, a milled recess 49, which is configured in the form of a width across flats and is arranged on the outside circumference of the control piston 15. The front surface 47 of the control piston 15 is in contact with a blunt needle tip 50 of a bearing needle 51, which is inserted in the housing 14 of the directional control valve 3 in the direction of the longitudinal axis 16 of the control piston 15. The control piston 15 is guided essentially in a sliding fashion in a blind borehole 52, which runs parallel to the blind borehole 40 for the clamping piston 7. The blind borehole 52 extends through the same stop face 41 of the housing 14 of the directional control valve 3 as the blind borehole 40 itself.

The diameter of the valve member 12 tapers off on its side opposite the front surface 47, so that a cylindrical compression spring 28 can be pushed on. The end of the compression spring that faces away from the control piston 15 is supported on a shaft 53 of a control knob 13. The shaft 53 runs in the housing 29 and has on its end, facing the compression spring 28, the same outside diameter as the control piston 15. The diameter of the shaft 53 tapers off into a first diameter diminution 54 inside the housing 29 in the direction of the control knob 13 and again at the exit from the housing 29. The shaft 53 extends through the control knob 13 and extends to some extent in this control knob with a spline shaft connection 55 (groove-spring). The control knob 13 is also secured with a cap nut 56, which is secured on a thread of the shaft 53. The control knob 13 can be operated manually, as shown in particular in FIG. 7, as a double wing rotary knob.

A spring chamber 57 for the compression spring 37 and a spring chamber 58 for the compression spring 28 are connected to a hydraulic fluid container T in the form of a tank port (cf. FIG. 7). Such a channel 59 runs, when viewed in the direction of FIGS. 2′ to 5, in the housing 14 of the directional control valve 3 in a parallel direction to the longitudinal axes 16, 17 and above the valve member 18. The channel 59 is arranged so as to diagonally traverse the flange plate 30 and, attached thereto, a housing region of the housing 29 and empties into the spring chamber 57. As shown in FIG. 7, the other end of this channel 59 opens out on a planarly milled side face 60 of the valve housing 29.

In the switching positions of the control piston 15 shown in FIGS. 3 and 5, such a spring chamber 58 is connected in a fluid-carrying manner to an additional hydraulic fluid container port T, which opens out from the side face 60 at a lower region (shown in FIG. 7), by means of the passage borehole 48 for the control piston 15.

As shown in FIG. 6 in a front view of the housing 29 and the control knob 13, the exemplary embodiment provides three switching positions A, B, C. In FIG. 6 and FIG. 2′, the control knob 13 occupies a switching position A as the home position and, in so doing, performs a so-called “kick-out” function (K.O.). At the same time, the clamping pressure p, which is applied to the front surface 47 of the control piston 15, is the load pressure p′ that is tapped by the pressure compensator 11 and is connected to the clamping piston working chamber 27 by way of the milled recess 49 and a branch duct (not shown) in the control piston 15 by means of a cross channel 61 in the housing 14 of the directional control valve 3.

When pressure is applied in an analogous manner to the working chamber 27, the clamping piston 7 can occupy a position as shown in FIG. 4. Then, in conjunction with a corresponding switching position of the valve member 18 that satisfies the operational requirements and when pressure is applied to a hydraulic consumer 10, the latching action may occur in that the detent bodies 5 fall into one of the two latching recesses 24 and 25. As a result, the latching piston 20 and the valve member 18, which is integrally formed with this latching piston, are secured in a releasable manner at the stop sleeve 35. The detent bodies 5, formed as balls, rest against the oblique or control surfaces 22 of the stop sleeve 35, which in turn is pressed against the guide bushing 34 by means of the higher spring bias of the compression spring 37 that is generated by the clamping piston 7.

If the LS pressure and also the pressure p′ in the working chamber 27 of the clamping piston 7 are lowered or brought to zero in the event of a breakdown or in the event that the hydraulic system is shut down, then, when the spring force of the compression spring 37 is lower and when the yielding clamping piston 7 is in the direction of the positions shown FIGS. 2′ and 5, the latching piston 20 can be moved into a position in which the detent bodies 5 are released and ejected (kicked-out) from the respective latching recess 24, 25, due to the energy storage mechanism 8, the helical compression spring 44, and the valve spring (not illustrated) (the other valve slide end).

In an additional switching position, all of the functions of the switching device 9 can be deactivated (cf. FIG. 5). Then the control knob 13 is in a position that is offset by 90°. Then the clamping piston working chamber 27 is set to passage to the lower hydraulic fluid tank port T by way of the cross channel 61 and the milled recess 49. This feature may be useful, for example, for continuous lifting and lowering work with a consumer 10, which is designed as a hydraulic cylinder, because the switching positions of the valve member can be continuously changed. In a third switching position of the switching device 9 (cf FIG. 3), the latching piston 20 can be set to a permanent locking action in that a clamping pressure p′, applied to the working chamber 27 of the clamping piston, is cut off from the pressure compensator 11 after the locking action has been completed. This features enables a continuous operation of the hydraulic motors.

For purposes of servicing and assembling the switching device 9, the housing 29 can be easily unscrewed from the housing 14 of the directional control valve 3 (not illustrated). A flat gasket 62 can serve as the simplest sealing element for sealing off the said fluid-carrying connections and the spring chambers between the two housings 14 and 29.

1. A device for locking an axially movable component (2) of a hydraulic system, wherein the axially movable component (2) can be releasably secured in a positively locking manner in at least one axial position by means of a detent mechanism (4) with at least one detent body (5), and with a release device (6) for releasing the respective detent body (5) from the axially movable component (2), wherein the detent mechanism (4) can be latched and released by means of a clamping piston (7) and using an energy storage mechanism (8), and wherein the clamping piston (7) can be moved in a working chamber (27), which can be subject to the action of a clamping pressure, characterized in that the clamping piston (7) can be adjusted at least into one switching position by a switching device (9), that the clamping pressure can be applied to the clamping piston (7) by means of the switching device (9), and that, in this switching position, the clamping piston can be moved out of its latching position by means of the energy storage mechanism (8) when there is a drop in the clamping pressure.

2. The device according to claim 1, characterized in that in an additional second switching position of the switching device (9), the hydraulic fluid of the clamping piston (7) can be removed from the working chamber (27) into a hydraulic fluid container (T), so that the component (2) can return into its neutral position.

3. The device according to claim 1, characterized in that in a third switching position of the switching device (9), the clamping piston (7) can be locked in each respectively occupied switching position, in particular in the latching position.

4. The device according to claim 1, characterized in that the component (2) is a control slide of a hydraulic directional control valve (3).

5. The device according to claim 1, characterized in that a load pressure (p′) of a consumer (10), which can be actuated preferably by the directional control valve (3), is applied as the clamping pressure to the switching device (9).

6. The device according to claim 2, characterized in that the switching device (9) can be moved manually into at least two, preferably three switching positions (A, B, C).

7. The device according to claim 1, characterized in that when the detent mechanism (4) is in a latching position, the switching device (9) applies to the clamping piston (7) a hydraulic fluid pressure, which corresponds to the initial pressure (p′) of a pressure compensator (11).

8. The device according to claim 2, characterized in that the switching device (9) has a valve member (12) that has at least two, preferably three switching positions (A, B, C), which can be produced by a rotational and translational movement.

9. The device according to claim 8, characterized in that the switching device (9) has a control knob (13), which can be rotated by about 180° and with which the at least two switching positions (A, B, C) of the valve member (12) of the switching device (9) can be preset.

10. The device according to claim 9, characterized in that the switching device (9) has a neutral position of its rotatable control knob (13), with which the clamping pressure is applied to the clamping piston (7).

11. The device according to claim 4, characterized in that the switching device (9) is integrated into a housing (14) of the hydraulic directional control valve (3) and that the clamping pressure in the housing (14) is guided from the directional control valve (3) to the switching device (9).

12. The device according to claim 4, characterized in that the switching device (9) has a valve member (12), which is formed as the control piston (15), and the longitudinal axis (16) of this valve member runs parallel to a longitudinal axis (17) of a valve member (18) of the hydraulic directional control valve (3).

13. The device according to claim 1, characterized in that the load pressure (p′) is separated from a pressure chamber (6) of the clamping piston (7) by means of a throttle point.
